(19) United States
(12) Patent Application Publication
(10) Pub. No.: US 2019/0005306 A1
(43) Pub. Date: Jan. 3, 2019

(54) ELECTRONIC DEVICE, IMAGE PROCESSING METHOD AND NON-TRANSITORY COMPUTER READABLE RECORDING MEDIUM

(71) Applicant: ASUSTeK COMPUTER INC., Taipei (TW)

(72) Inventors: Tsung-Lun WU, TAIPEI (TW); Wei-Po LIN, TAIPEI (TW); Chia-Hui HAN, TAIPEI (TW); Fu-Chun MAI, TAIPEI (TW)

(21) Appl. No.: 16/019,612

(22) Filed: Jun. 27, 2018

(30) Foreign Application Priority Data
Jul. 3, 2017 (TW) 106122273

(51) Int. Cl. G06K 9/00; G06T 7/13

(52) U.S. Cl. CPC G06K 9/00248; G06T 7/13; G06K 9/00281

(57) ABSTRACT

The present disclosure provides an electronic device, an image processing method and a non-transitory computer readable recording medium. The image processing method comprises: adjusting a position of at least one of multiple facial feature points on a facial three-dimensional model according to an adjustment instruction; adjusting the facial three-dimensional model correspondingly according to adjusted facial feature points to generate an adjusted facial three-dimensional model; and displaying the adjusted facial three-dimensional model.

### CROSS-REFERENCE TO RELATED APPLICATION

This application claims the priority benefit of TW application serial No. 106122273, filed on Jul. 3, 2017. The entirety of the above-mentioned patent application is hereby incorporated by references herein and made a part of specification.

### BACKGROUND OF THE INVENTION

### Field of the Invention

The disclosure relates to an electronic device, an image processing method and a non-transitory computer readable recording medium and, more specifically, to an electronic device and an image processing method presenting a reshaped face.

### Description of the Related Art

Facial reshaping becomes popular due to the pursuit of beauty. Generally, before a plastic operation, a reshaped picture after the plastic operation is simulated via a computer to ensure that the reshaped face meets the requirement of users.

### BRIEF SUMMARY OF THE INVENTION

According to a first aspect of the disclosure, an electronic device is provided. The electronic device comprises: a three-dimensional scanner configured to obtain a facial three-dimensional information; a processor, electrically connected to the three-dimensional scanner, the processor is configured to adjust a position of at least one of multiple facial feature points on a facial three-dimensional model according to an adjustment instruction and generate adjusted facial feature points, and the processor adjusts the facial three-dimensional model correspondingly according to adjusted facial feature points to generate an adjusted facial three-dimensional model; and a monitor electrically connected to the processor, the monitor is configured to display the adjusted facial three-dimensional model.

According to a second aspect of the disclosure, an image processing method for an electronic device is provided. The image processing method comprises: adjusting a position of at least one of multiple facial feature points on a facial three-dimensional model according to an adjustment instruction and generating adjusted facial feature points; adjusting the facial three-dimensional model correspondingly according to adjusted facial feature points to generate an adjusted facial three-dimensional model; and displaying the adjusted facial three-dimensional model.

According to a third aspect of the disclosure, a non-transitory computer readable recording medium is provided. The non-transitory computer readable recording medium stores at least one program instruction. The at least one program instruction executes the following steps after the program instruction is loaded in an electronic device: adjusting a position of at least one of multiple facial feature points on a facial three-dimensional model according to an adjustment instruction and generating adjusted facial feature points; adjusting the facial three-dimensional model correspondingly according to adjusted facial feature points to generate an adjusted facial three-dimensional model; and displaying the adjusted facial three-dimensional model.

### BRIEF DESCRIPTION OF THE DRAWINGS

These and other features, aspects and advantages of the invention will become better understood with regard to the following embodiments and accompanying drawings.

FIG. 1 is a block diagram of an electronic device according to an embodiment.

FIG. 2 is a flow chart of an image processing method according to an embodiment.

FIGS. 3A and 3B are schematic diagrams of a facial three-dimensional model with facial feature points on the facial three-dimensional model.

FIG. 4 is a flow chart of an image processing method according to an embodiment.

### DETAILED DESCRIPTION OF THE EMBODIMENTS

These and other features, aspects, and advantages of the present invention will become better understood with regard to the following description, appended claims, and accompanying drawings. However, the invention is not limited to the embodiments. The description of the operation of components is not used for limiting the execution sequence. Any equivalent device with the combination according to the disclosure of the invention is in the scope of the invention. The components shown in figures are not used for limit the size or the proportion. The same or similar number denotes the same or similar components.

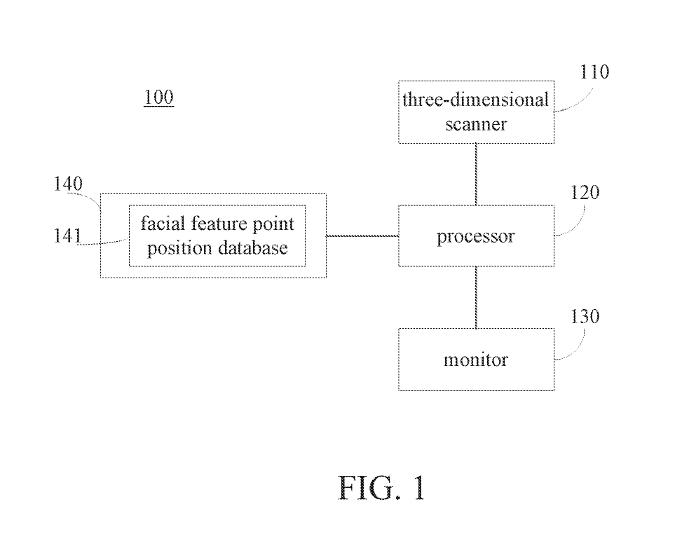

FIG. 1 is a block diagram of an electronic device 100 according to an embodiment. As shown in FIG. 1, an electronic device 100 includes a three-dimensional scanner 110, a processor 120 and a monitor 130. In an embodiment, the electronic device 100 further includes a memory 140. The memory 140 is electronically connected to the processor 120.

The three-dimensional scanner 110 is configured to detect and analyze the appearance of an object in physical space, and reconstruct the scanned object in virtual space via a three-dimensional reconstruction computing method. In an embodiment, the three-dimensional scanner 110 scans the object in a contactless way, such as a time-of-flight method, a triangulation method, a handhold laser method, a structured lighting method or a modulated lighting method of an non-contact active scanning, and a stereoscopic method, a shape from shading method, a photometric stereo method or a silhouette method of an non-contact passive scanning, which is not limited herein.

The processor 120 is configured to control various devices connected to the processor 120 according to instructions or programs, and is configured to calculate and process data. In an embodiment, the processor 120 is a central processor unit or a system on chip (SOC), which is not limited herein.

The monitor 130 is used to display images and colors. In an embodiment, the monitor 130 is a liquid crystal display (LCD, a thin film transistor liquid crystal display (TFT-LCD), a light emitting diode display (LED display), a plasma display panel display or an organic light emitting diode display (OLED display), which is not limited herein.

The memory 140 includes a facial feature point position database 141. The facial feature point position database 141 includes combinations of multiple facial feature points corresponding to different face types (such as the face size). In an embodiment, the memory 140 is a hard disk drive (HDD), a solid state disk (SSD) or a redundant array of independent disks (RAID), which is not limited herein.

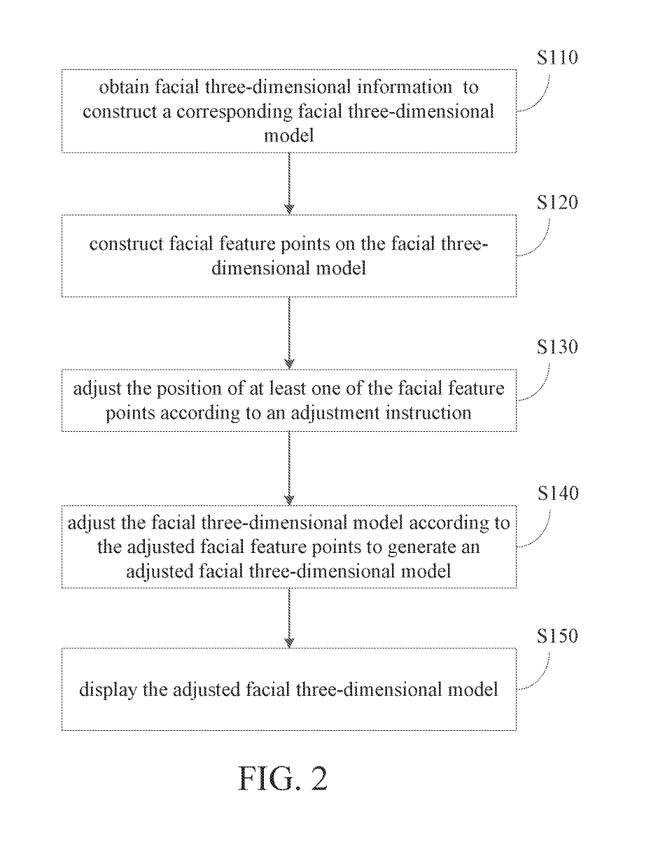

FIG. 2 is a flow chart of an image processing method according to an embodiment. In some embodiments, an image processing method in the flowchart is achieved by a non-transitory computer-readable medium. The non-transitory computer-readable medium reads at least one program instruction. After the program instruction is loaded to the electronic device 100, the steps are executed. The image processing method shown in FIG. 2 is executed by the electronic device 100 to show the face effect after the plastic operation.

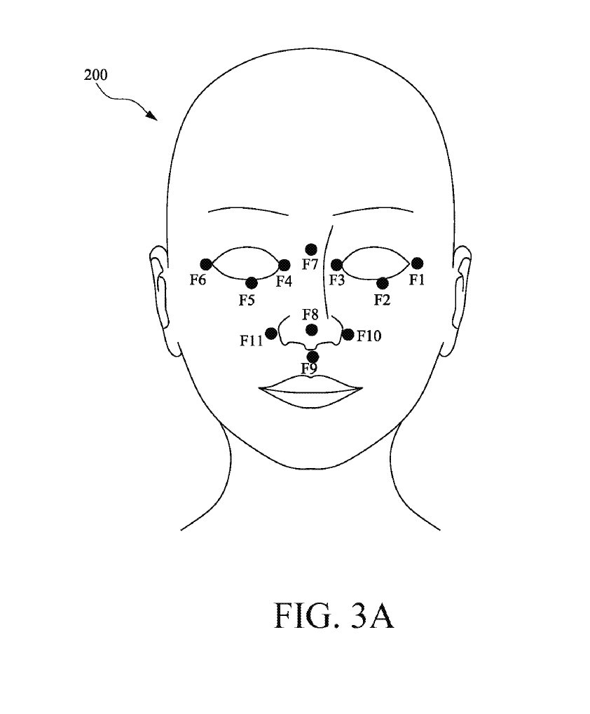

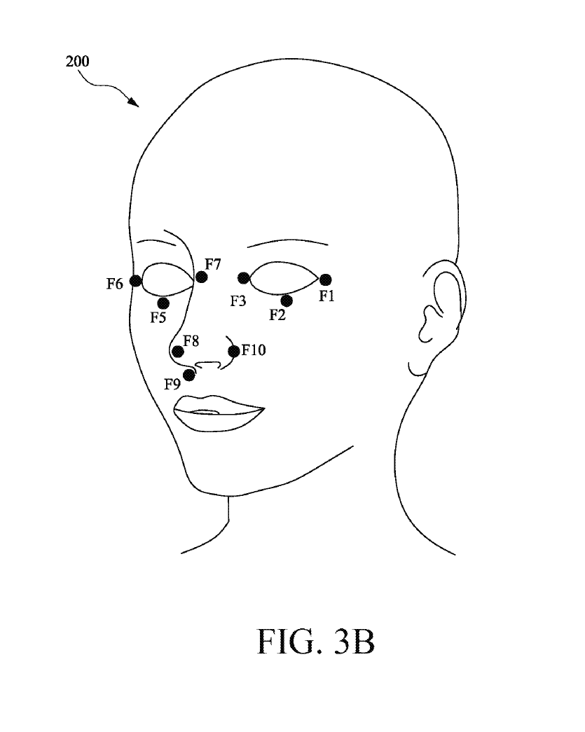

As shown in FIG. 2, in step S110, facial three-dimensional information is obtained to construct a corresponding facial three-dimensional model. Please refer to FIGS. 3A and 3B. FIGS. 3A and 3B are schematic diagrams of a facial three-dimensional model 200 and facial feature points F1 to F11 thereon in different view angles.

In an embodiment, in step S110, the user face is scanned by the three-dimensional scanner 110 to obtain the facial three-dimensional information.

Furthermore, the three-dimensional scanner 110 scans the face in a non-contact scanning way and generates the three-dimensional information corresponding to the face. The three-dimensional information includes facial information, such as a facial shape, a distance between two eyes, an ear shape, a nasion height, a lip shape and an eyebrow shape. However, the scanning way of the three-dimensional scanner 110 is not limited herein.

Then, the processor 120 receives the three-dimensional information to construct the corresponding facial three-dimensional model 200. In an embodiment, the three-dimensional scanner 110 obtains the three-dimensional information and then constructs the facial three-dimensional model 200 directly.

In step S120, the processor 120 constructs facial feature points F1˜F11 on the facial three-dimensional model 200 according to the facial feature point position database 141. The facial feature points F1˜F11 move with the facial three-dimensional model 200 instantly. In detail, after the processor 120 determines the facial shape category of the facial three-dimensional model 200, a combination of facial feature points corresponding to the facial shape category of the facial three-dimensional model 200 is selected from the facial feature point position database 141 automatically, and the combination of the selected facial feature points is constructed on the facial three-dimensional model 200. The combination of facial feature points move with the facial three-dimensional model 200 instantly.

In an embodiment, after the three-dimensional scanner 110 constructs the facial three-dimensional model 200, the facial feature points F1 to F11 are determined. In detail, after the three-dimensional scanner 110 determines the facial shape category of the facial three-dimensional model 200, the processor 120 selects a combination of facial feature points corresponding to the facial shape category of the facial three-dimensional model 200 from the facial feature point position database 141, and constructs a combination of the selected facial feature points on the facial three-dimensional model 200. The combination of facial feature points moves with the facial three-dimensional model 200 instantly.

In step S130, the processor 120 adjusts the position of at least one of the facial feature points F1˜F11 according to an adjustment instruction. Only the facial feature points F1˜F11 corresponding to eyes and nose are shown in FIGS. 3A and 3B. Facial feature points corresponding to other parts (such as a forehead, a lip, a jaw and ears) are not shown for a concise purpose. Eyes and a nose are regarded as parts to be reshaped in following embodiments. First, eyes are taken as an example of a reshaped part.

In an embodiment, in the step of adjusting the position of at least one of the facial feature points according to an adjustment instruction further includes an instruction of selecting a reshaped part, an instruction of selecting the facial feature points or an instruction of adjusting the facial feature points.

In the step of selecting a reshaped part, eyes are selected as the part to be reshaped via a user interface (not shown).

In the step of selecting the facial feature points, the facial feature points F1˜F6 corresponding to eyes are selected when eyes are selected as the part to be reshaped.

In the step of adjusting the facial feature points, eyes of the facial three-dimensional model 200 are reshaped by adjusting positions of the facial feature points F1˜F6 when the facial feature points F1˜F6 are selected.

Furthermore, the positions of the facial feature points F1 to F6 are adjusted manually or automatically according to a plastic operation selected by the user. For example, the user selects an open canthus operation and adjusts the positions of the facial feature points manually. The positions of the facial feature points F1˜F6 are adjusted manually to reduce the distance between the facial feature point F3 and the facial feature point F4. The adjustment amount is controllable. The shapes of the eyes after reshaped are presented. In an embodiment, the positions of the facial feature points are automatically adjusted. For example, when the user selects the open canthus operation, the positions of the facial feature points F1˜F6 are adjusted automatically. Then, multiple corresponding preset position groups with different adjustment amounts are shown for users to choose.

In an embodiment, the Eye Lift operation is selected. Taking a manual adjustment as an example, the user adjusts the positions of the facial feature points F1˜F6 manually. The facial feature point F1 and the facial feature point F6 are moved up. Taking an automatic adjustment as an example, the positions of the facial feature points F1˜F6 are adjusted automatically to show multiple corresponding preset position groups with different adjustment amounts. Then, the user can make a choice.

In the following embodiment, a nose is selected to be reshaped.

In the step of selecting a reshaped part, the nose is selected as the part to be reshaped via a user interface (not shown).

In the step of selecting the facial feature points, the facial feature points F7˜F11 corresponding to the nose are further selected.

In the step of adjusting the facial feature points, the shape of the nose of the facial three-dimensional model 200 is reshaped by adjusting positions of the facial feature points F7 F11.

Furthermore, the positions of the facial feature points F7˜F11 are adjusted manually or automatically according to a plastic operation selected by the user. For example, when the user selects augmentation rhinoplasty operation, taking a manual adjustment as an example, the user adjusts the positions of the facial feature points F7˜F11 manually. Especially, the height of the facial feature point F7 is increased. The adjustment amount is controllable. The shape of the nose after reshaped is presented. Taking an automatic adjustment as an example. When the user selects the augmentation rhinoplasty operation, the positions of the facial feature points F7 F11 are automatically adjusted to multiple corresponding preset position groups with different adjustment amounts. Then, the user can make a choice.

When the user selects alar base reduction operation, taking a manual adjustment as an example, the user adjusts the positions of the facial feature points F7˜F11 manually. Especially, the distance between the facial feature point F10 and the facial feature point F11 is decreased. Taking an automatic adjustment as an example, when the user selects the alar base reduction operation, the positions of the facial feature points F7˜F11 are adjusted automatically to multiple corresponding preset position groups with different adjustment amounts. Then, the user can make a choice.

The adjustments of the facial feature points F1 to F11 corresponding to the eyes and the nose are only taken as an example, which is not limited herein.

In an embodiment, the adjustment instruction is generated via a voice signal, which is not limited herein. The steps of selecting a reshaped part, selecting the facial feature points, and adjusting the facial feature points to generate adjusted facial feature points are executed when the corresponding voice signal is received.

In step S140, the processor 120 adjusts the facial three-dimensional model 200 according to the adjusted facial feature points to generate the adjusted facial three-dimensional model.

In step S150, the monitor 130 displays the adjusted facial three-dimensional model. Then, the user can see a reshaped facial three-dimensional model on the monitor 130.

The reshaped face is simulated via the electronic device 100 before a plastic surgery. Thus, users can ensure whether the reshaped face meets her or his requirement. Moreover, since the facial three-dimensional information is obtained via the 3D scanning, the head shape does not need to be adjusted again. Moreover, the facial three-dimensional model constructed according to the three-dimensional information looks lifelike.

In an embodiment, During executing step S120 to Step S130, following steps are further executed: detecting an instant facial image of a face, adjusting positions and angles of the facial three-dimensional model 200 according to the detected instant facial image to make the positions and the angles of the facial three-dimensional model 200 match the positions and angles of the instant facial image. Then, the facial three-dimensional model 200 moves with the instant facial image (not shown). For example, when the head in the instant image turns right, the facial three-dimensional model 200 (or the adjusted facial three-dimensional model) presented on the monitor 130 also turns right synchronously. When the head in the instant image is raised, the facial three-dimensional model 200 (or the adjusted facial three-dimensional model) presented on the monitor 130 also turns upwards synchronously. That is to say, when the user face moves, the facial three-dimensional model 200 (or the adjusted facial three-dimensional model) also moves correspondingly with the movement of the user face. In an embodiment, the instant image of the user face is detected via the three-dimensional scanner 110. In another embodiment, the instant image of the user face is detected via an image capturing unit (not shown) of the electronic device 100. For example, the image capturing unit is a camera.

Therefore, since the user face moves with the facial three-dimensional model 200 (or the adjusted facial three-dimensional model) synchronously, the user could move his face freely to see the facial three-dimensional model 200 (or the adjusted facial three-dimensional model) in different angles.

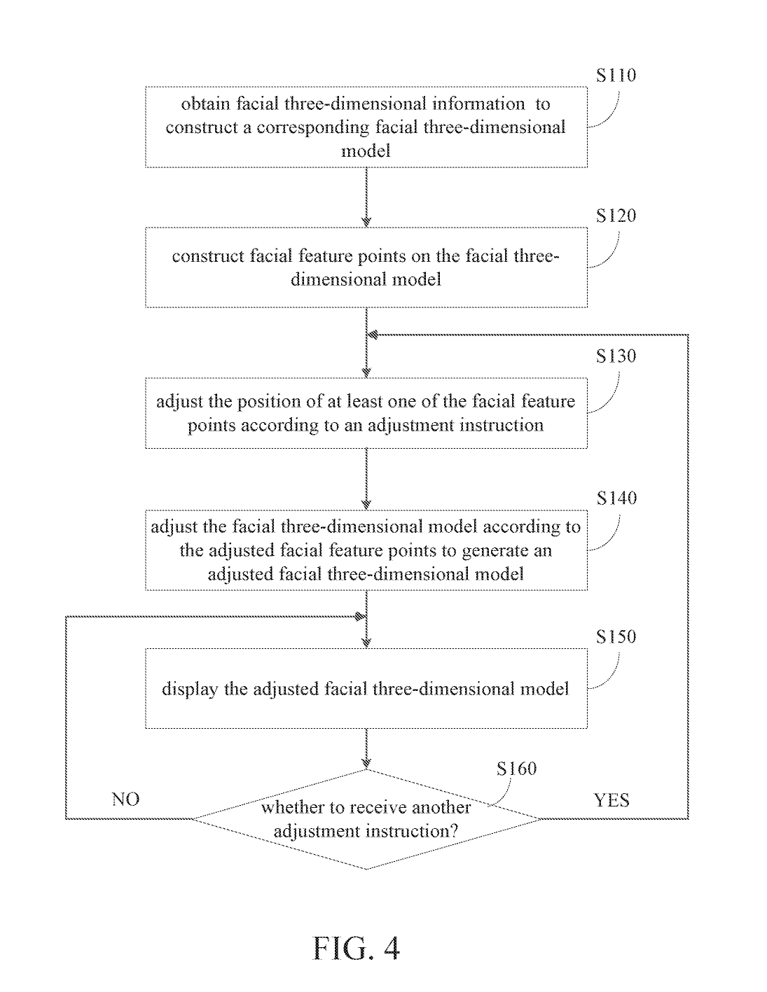

Please refer to FIG. 4 again. FIG. 4 is a flow chart of an image processing method according to an embodiment. As shown in FIG. 4, the method of presenting a reshaped face instantly shown in FIG. 4 is similar to the method of presenting a reshaped face instantly shown in FIG. 2. The difference is that the method of presenting a reshaped face instantly shown in FIG. 4 further includes step S160 after step S150. In step S160, whether to receive another adjustment instruction is determined. When an adjustment instruction is received, step S130 is executed. When no adjustment instruction is received, step S150 is executed.

For example, in an embodiment, after step S150 is executed, according to a current adjustment instruction, the user sees the facial three-dimensional model 200 (or the adjusted facial three-dimensional model) on an image on the monitor 130. When the user face moves, the facial three-dimensional model 200 (or the adjusted facial three-dimensional model) also moves correspondingly. When the user is not satisfied with the current facial three-dimensional model 200 (or the adjusted facial three-dimensional model), the user inputs another adjustment instruction according to his or her requirement. Then, steps S130, S140 and S150 are executed. Steps S130, S140 and S150 are the same as those in the above embodiment, which is not descripted again. When the user is satisfied with the current facial three-dimensional model 200 (or the adjusted facial three-dimensional model), the user does not input another adjustment instruction. Then, the method goes back to step S150. In step S150, the current facial three-dimensional model 200 (or the adjusted facial three-dimensional model) is displayed.

In conclusion, according to the electronic device and the image processing method in embodiments, with the cooperation of the processor and the monitor, the user facial three-dimensional information is obtained in a step of 3D scanning via the three-dimensional scanner. Therefore, the head shape does not need to be adjusted again. Furthermore, the facial three-dimensional model constructed via the three-dimensional information looks lifelike. Moreover, a reshaped face is presented instantly.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. An electronic device, comprising:
a three-dimensional scanner configured to obtain a three-dimensional information of a face;
a processor, electrically connected to the three-dimensional scanner, the processor is configured to adjust at least a position of at least one of multiple facial feature points on a facial three-dimensional model according to an adjustment instruction to generate adjusted facial feature points, and the processor adjusts the facial three-dimensional model according to adjusted facial feature points to generate an adjusted facial three-dimensional model; and
a monitor electrically connected to the processor, the monitor is configured to display the adjusted facial three-dimensional model.

2. The electronic device according to claim 1, wherein the processor receives the three-dimensional information of the face to construct a facial three-dimensional model corresponding to the face, and the facial feature points are constructed on the facial three-dimensional model via the processor.

3. The electronic device according to claim 1, wherein the facial feature points are constructed on the facial three-dimensional model via the three-dimensional scanner after the facial three-dimensional information is obtained.

4. The electronic device according to claim 1, wherein the electronic device further comprises an image capturing unit, the image capturing unit captures an instant facial image, the processor receives the instant facial image from the image capturing unit, and matches positions and angles of the facial three-dimensional model with the positions and the angles of the instant facial image to move with the face synchronously.

5. The electronic device according to claim 1, wherein the three-dimensional scanner obtains an instant facial image, the processor receives the instant facial image from the three-dimensional scanner, and matches positions and angles of the facial three-dimensional model with the positions and the angles of the instant facial image to move with the face synchronously.

6. The electronic device according to claim 1, wherein the processor constructs the facial feature points on the facial three-dimensional model according to a facial feature point position database.

7. An image processing method for an electronic device, the image processing method comprising:
adjusting at least a position of at least one of multiple facial feature points on a facial three-dimensional model according to an adjustment instruction and generating adjusted facial feature points;
adjusting the facial three-dimensional model according to the adjusted facial feature points to generate an adjusted facial three-dimensional model; and
displaying the adjusted facial three-dimensional model.

8. The image processing method according to claim 7, wherein before the step of adjusting the at least a position of at least one of multiple facial feature points on the facial three-dimensional model according to the adjustment instruction, the method further comprises:
receiving three-dimensional information of a face to construct the facial three-dimensional model corresponding to the face, and
constructing the facial feature points on the facial three-dimensional model.

9. The image processing method according to claim 8, wherein after the step of receiving the three-dimensional information of the face to construct the facial three-dimensional model corresponding to the face, the method further comprises:
detecting an instant facial image of the face; and
matching positions and angles of the facial three-dimensional model with the positions and the angles of the instant facial image to synchronously.

10. The image processing method according to claim 8, wherein the step of constructing the facial feature points on the facial three-dimensional model comprises:
constructing the facial feature points on the facial three-dimensional model according to a facial feature point position database.

11. A non-transitory computer readable recording medium, the non-transitory computer readable recording medium stores at least one program instruction, after the program instruction is loaded in an electronic device, executing the following steps:
adjusting at least a position of at least one of multiple facial feature points on a facial three-dimensional model according to an adjustment instruction and generating adjusted facial feature points;
adjusting the facial three-dimensional model correspondingly according to adjusted facial feature points to generate an adjusted facial three-dimensional model; and
displaying the adjusted facial three-dimensional model.
